(19) United States
(12) Patent Application Publication
(10) Pub. No.: US 2008/0191635 A1
(43) Pub. Date: Aug. 14, 2008

(54) Multi-lamp backlight module

(76) Inventors: Chun-Kong Chan, Hsi Chih City (TW); Jeng-Shong Wang, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/703,630

(22) Filed: Feb. 8, 2007

(51) Int. Cl. H05B 37/02

(52) U.S. Cl. 315/235

(57) ABSTRACT

A multi-lamp backlight module integrates the capacitors into a circuit board, and the circuit board is located on the liquid crystal display panel. The backlight module includes a driving unit having a driving transformer, and a backlight unit. The driving transformer provides two output terminals. The backlight unit includes a circuit board and at least one CCFL. The circuit board is located at the liquid crystal display panel. The circuit board has at least one capacitor, and first ends of the capacitors are commonly connected with one output terminal of the driving transformer. The CCFLs are located on a back side of the liquid crystal display panel. First ends of the CCFLs are commonly connected with another output terminal of the driving transformer, and second ends of the CCFLs are respectively connected with the second ends of the capacitors.

### BACKGROUND OF THE INVENTION

1. Field of the Invention

The present invention relates to a multi-lamp backlight module. In particular, this invention relates to a multi-lamp backlight module that reduces the required electronic elements, simplifies the circuit design to reduce costs, and balances current better.

2. Description of the Related Art

Liquid crystal display devices usually include a liquid crystal display panel and a backlight module. The backlight module can be divided into a bottom lighting backlight module and a side lighting backlight module.

Both of the backlight modules need at least one driving circuit board to drive the lighting unit in the backlight module. The CCFL is usually used as the lighting unit. The lighting unit is driven by a high-voltage driving signal provided from the driving circuit board.

FIG. 1 shows a schematic diagram of a backlight module circuit of the prior art. The backlight module 1 of the prior art uses a plurality of driving transformers T1˜TN to provide high-voltage driving signals to the CCFLs L1˜LN via the capacitors C1˜CN for driving the CCFLs L1˜LN by a one-to-one method. Reference is made to FIGS. 1 and 2. FIG. 2 shows a schematic diagram of the circuit allocation of FIG. 1. The driving transformers T1˜TN are located on a control circuit board 10, each of the driving transformers T1˜TN have two output terminals. All of the output terminals are commonly connected with the reference point of the control circuit board 10. Another output terminal is individually connected with the capacitors C1˜CN on the control circuit board 10. In the allocation of the circuit elements, a plurality of connecting pins 12 are installed on the control circuit board 10 as connecting interfaces between the control circuit board 10 and the CCFLs L1˜LN. The high-voltage driving signals outputted from the control circuit board 10 are transmitted to CCFLs L1˜LN via the connecting pins 12 for driving the CCFLs L1˜LN.

Furthermore, as shown in FIG. 2, when the backlight module 1 is assembled, the control circuit board 10 and the CCFLs L1˜LN are connected together via the connecting pins 12 and the connecting wires 14. The assembling process has to be implemented manually. In other words, it cannot be automatically manufactured. The connecting pins 12 and the connecting wires 14 are composed of anti-high-voltage material. The cost is high.

Reference is made to FIG. 3, which shows another schematic diagram of a backlight module circuit of the prior art. The backlight module 2 of the prior art uses a driving transformer Tr to provide high-voltage driving signals to the CCFLs L1˜LN via the balance windings LX1˜LXN for driving the CCFLs L1˜LN by a one-to-multi method. Reference is made to FIGS. 3 and 4. FIG. 4 shows a schematic diagram of the circuit allocation of FIG. 1. In FIG. 4, the driving transformers Tr1 and Tr2 are located on a control circuit board 20. Each of the driving transformers Tr1 and Tr2 has two output terminals. Both of the output terminals are commonly connected with the reference point of the control circuit board 20. Another output terminal is individually connected with the balance windings LX1˜LXN on the control circuit board 10. In the allocation of the circuit elements, a plurality of connecting pins 12 are installed on the control circuit board 10 as connecting interfaces between the control circuit board 20 and the CCFLs L1˜LN. The high-voltage driving signals outputted from the control circuit board 20 are transmitted to CCFLs L1˜LN via the connecting pins 22 for driving the CCFLs L1˜LN.

Furthermore, as shown in FIG. 4, when the backlight module 2 is assembled, the control circuit board 20 and the CCFLs L1˜LN are connected together via the connecting pins 22 and the connecting wires 24. The assembling process has to be implemented manually. In other words, it cannot be automatically manufactured. The connecting pins 22 and the connecting wires 24 are composed of anti-high-voltage material. The cost is high.

### SUMMARY OF THE UVENTION

One particular aspect of the present invention is to provide a multi-lamp backlight module. The multi-lamp backlight module integrates the capacitor into a circuit board and the circuit board is located on the liquid crystal display panel. The allocation of circuit elements reduces the balance windings, the connecting pins, and the connecting wires so that the circuit is simplified. The cost is reduced and the circuit balances current better.

The first embodiment of the multi-lamp backlight module is used for a liquid crystal display panel. The backlight module includes a control circuit board, a transformer, a circuit board, and at least one CCFL. The transformer is located on the control circuit board, and the secondary side of the transformer has a first connecting terminal and a second connecting terminal. On the circuit board, there is at least one capacitor. The circuit board is located at the liquid crystal display panel, and one end of the each of the capacitors are commonly connected with the first connecting terminal of the secondary side of the transformer. The CCFLs are located on the back side of the liquid crystal display panel. Each of the CCFLs has a first conducting terminal and a second conducting terminal. The first conducting terminals are individually connected with a second end of the capacitors. The second conducting terminals are commonly connected with the second connecting terminal of the secondary side of the transformer.

The second embodiment of the multi-lamp backlight module is used for a liquid crystal display panel. The backlight module includes a control circuit board, a transformer, a first circuit board, a second circuit board, and at least one CCFL. The transformer is located on the control circuit board, and the secondary side of the transformer has a first connecting terminal and a second connecting terminal. On the first circuit board, there is at least one first capacitor. The first circuit board is located on the liquid crystal display panel, and one end of each of the first capacitors are commonly connected with the first connecting terminal of the secondary side of the transformer. On the second circuit board, there is at least one second capacitor. The second circuit board is located on the liquid crystal display panel, and one end of each of the second capacitors are commonly connected with the second connecting terminal of the secondary side of the transformer. The CCFLs are located on the back side of the liquid crystal display panel. Each of the CCFLs has a first conducting terminal and a second conducting terminal. The first conducting terminals are individually connected with a second end of the first capacitors. The second conducting terminals are individually connected with a second end of the second capacitors.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of a backlight module circuit of the prior art;

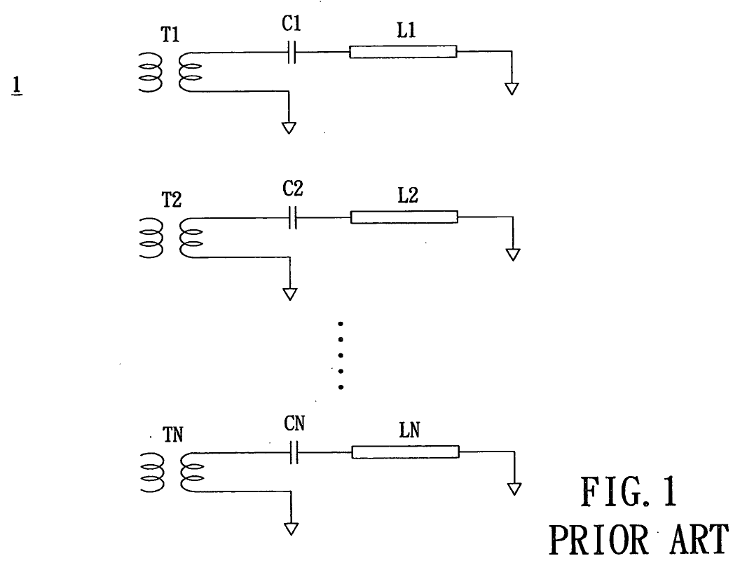

FIG. 2 is a schematic diagram of the circuit allocation of FIG. 1;

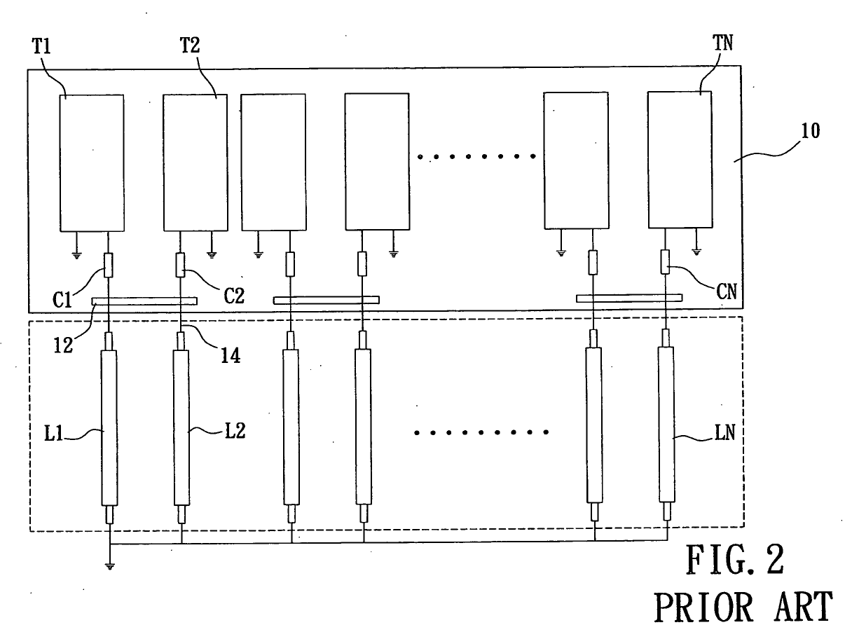

FIG. 3 is a schematic diagram of another backlight module circuit of the prior art;

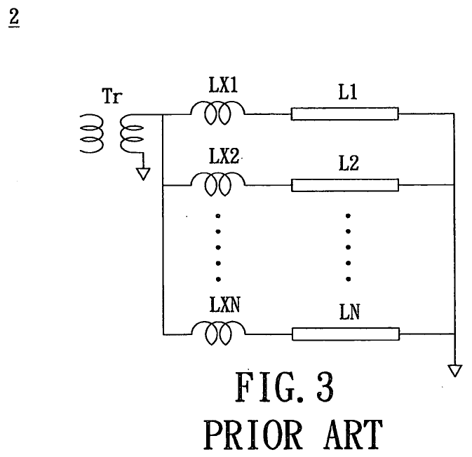

FIG. 4 is a schematic diagram of the circuit allocation of FIG. 4;

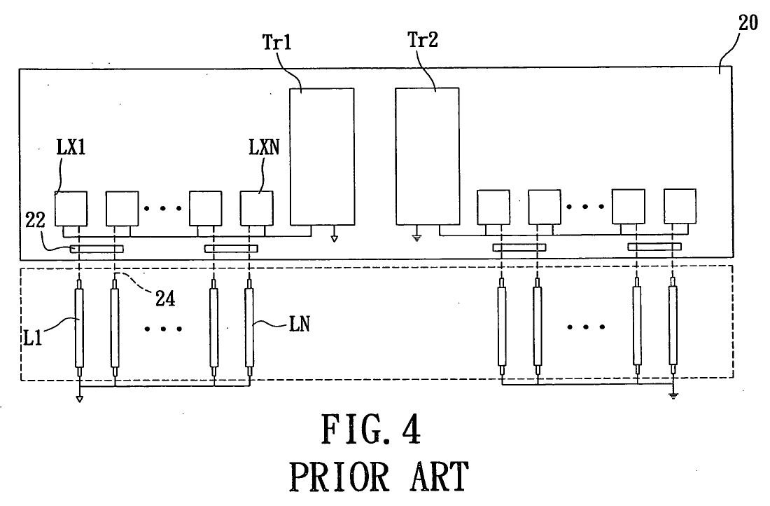

FIG. 5 is a schematic diagram of a backlight module circuit of the first embodiment of the present invention;

FIG. 6 is a schematic diagram of the circuit allocation of FIG. 5;

FIG. 7 is a schematic diagram of a backlight module circuit of the second embodiment of the present invention; and

FIG. 8 is a schematic diagram of the circuit allocation of FIG. 7.

### DETAILED DESCRIPTION OF THE PREFERRED EMBODIMENTS

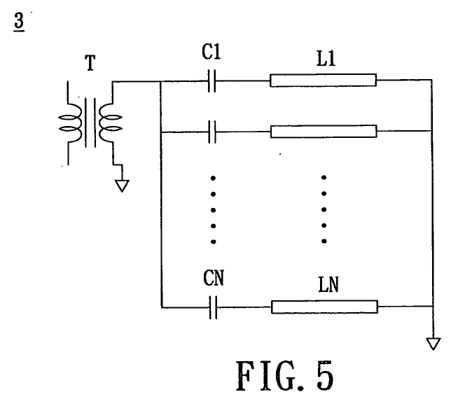

Reference is made to FIG. 5, which shows a schematic diagram of a backlight module circuit of the first embodiment of the present invention. The backlight module 3 of the present invention uses a driving transformer T to provide high-voltage driving signals to the CCFLs L1˜LN via the high-voltage capacitors C1˜CN for driving the CCFLs L1˜LN by a one-to-multi method. The backlight module is used for a liquid crystal display panel (not shown in the figure).

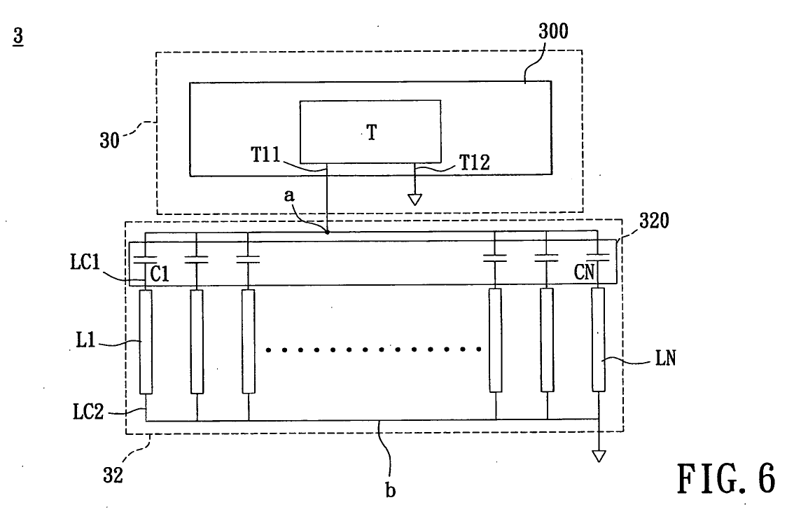

Reference is made to FIGS. 5 and 6. FIG. 6 shows a schematic diagram of the circuit allocation of FIG. 5. The backlight module 3 includes a driving unit 30 and a backlight unit 32. The driving unit 30 includes a control circuit board 300 and a driving transformer T. The backlight unit 32 includes a circuit board 320, and CCFLs L1˜LN. The driving transformer T is located on the control circuit board 300, and the secondary side of the driving transformer T has a first connecting terminal T11 and a second connecting terminal T12. On the circuit board 320, there is at least one capacitor C1˜CN. The circuit board 320 is located on the liquid crystal display panel (not shown in the figure), and one end of each the capacitors C1˜CN are commonly connected with the first connecting terminal T11 of the secondary side of the driving transformer T. The CCFLs L1˜LN are located on the back side of the liquid crystal display panel. Each of the CCFLs L1˜LN has a first conducting terminal LC1 and a second conducting terminal LC2. The first conducting terminals LC1 are individually connected with a second end of the capacitors C1˜CN. The second conducting terminals LC2 are commonly connected with the second connecting terminal T12 of the secondary side of the driving transformer T.

Reference is made to FIG. 6. In the driving unit 30 of the backlight module 3, the driving transformer T is located on the control circuit board 300, and two output connecting terminals T11, T12 are located on the control circuit board 300 for outputting high-voltage driving signals to the backlight unit 32. In the backlight unit 32, the circuit board 320 located with the capacitors C1˜CN is located on the liquid crystal display panel. First ends of the capacitors C1˜CN are commonly connected with the first connecting terminals T11 of the secondary side of the driving transformer T. The first conducting terminals LC1 of the CCFLs L1˜LN located on the back side of the liquid crystal display panel are individually connected with a second end of the capacitors C1˜CN. The second conducting terminals LC2 of the CCFLs L1˜LN are commonly connected with the second conducting terminal T12 of the secondary side of the driving transformer T.

Reference is made to FIG. 6. For the backlight module 3 of the first embodiment of the present invention, the driving unit 30 merely provides the first connecting terminal T11 and the second connecting terminal T12 to respectively connect with the common terminal a of the circuit board 30 and the common terminal b of the CCFLs L1˜LN in backlight unit 32.

Therefore, when the backlight module 3 of the first embodiment of the present invention is assembled, it only requires two high-voltage conducting wires for connecting the driving unit 30 and the backlight unit 32. The required manpower is reduced. Furthermore, because the driving unit 30 is connected with the backlight unit 32 via two conducting wires, the anti-high-voltage connecting pins and the connecting wires are not required again. Theses elements are omitted, and the manufacturing cost is reduced.

Because the backlight module 3 of the first embodiment of the present invention connects the high-voltage capacitors C1˜CN with one end of the CCFLs L1˜LN in serial, the operating current flowing through the CCFLs L1˜LN will be balanced due to the same high voltage. The additional balance winding does not need to be installed in the driving unit 30 so that the manufacturing cost is reduced.

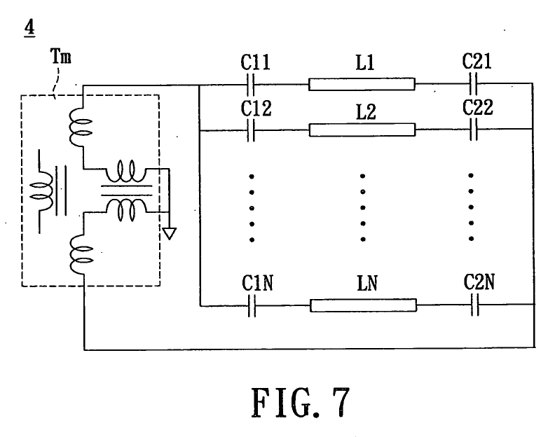

Reference is made to FIG. 7, which shows a schematic diagram of a backlight module circuit of the second embodiment of the present invention. The backlight module 4 of the present invention uses a driving transformer Tm to provide high-voltage driving signals to the CCFLs L1˜LN via the high-voltage capacitors C1 CN for driving the CCFLs L1˜LN by a one-to-multi method. The backlight module 4 is used for a liquid crystal display panel (not shown in the figure).

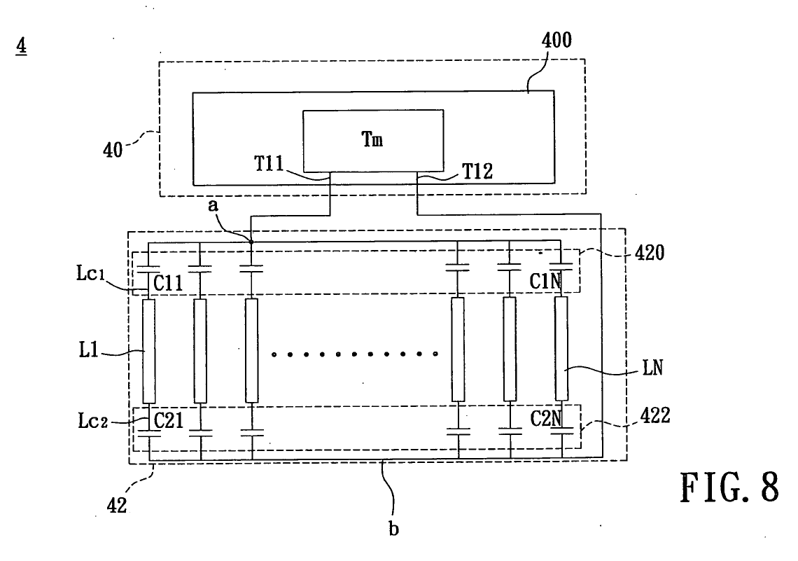

Reference is made to FIGS. 7 and 8. FIG. 8 shows a schematic diagram of the circuit allocation of FIG. 5. The backlight module 4 includes a driving unit 40 and a backlight unit 42. The driving unit 40 includes a control circuit board 400 and a driving transformer Tm. The backlight unit 42 includes a first circuit board 420, a second circuit board 422, and at least one CCFLs L1˜LN. The driving transformer Tm is located on the control circuit board 400, and the secondary side of the driving transformer Tm has a first connecting terminal T11 and a second connecting terminal T12. On the first circuit board 420, there is at least one first capacitor C11˜C1N. The first circuit board 420 is located on the liquid crystal display panel, and the first ends of the first capacitors C11˜C1N are commonly connected with the first connecting terminal T11 of the secondary side of the driving transformer Tm. On the second circuit board 422, there is at least one second capacitor C21˜C2N. The second circuit board 422 is located at the liquid crystal display panel, and the first ends of the second capacitors C21˜C2N are commonly connected with the second connecting terminal T12 of the secondary side of the driving transformer Tm. The CCFLs L1˜LN are located on the back side of the liquid crystal display panel. Each of the CCFLs L1˜LN has a first conducting terminal LC1 and a second conducting terminal LC2. The first conducting terminals LC1 are individually connected with second ends of the first capacitors C11˜C1N. The second conducting terminals LC2 are individually connected with second ends of the second capacitors C21˜C2N.

Reference is made to FIG. 8. For the backlight module 4 of the second embodiment of the present invention, the driving unit 40 merely provides the first connecting terminal T11 and the second connecting terminal T12 to respectively connect with the common terminal a of the first circuit board 420 and the common terminal b of the second circuit board 422 in backlight unit 42.

Therefore, when the backlight module 4 of the second embodiment of the present invention is assembled, it only requires two high-voltage conducting wires for connecting the driving unit 40 and the backlight unit 42. The required manpower is reduced. Furthermore, because the driving unit 40 is connected with the backlight unit 42 via two conducting wires, the anti-high-voltage connecting pins and the connecting wires are not required again. Theses elements are omitted, and the manufacturing cost is reduced.

Furthermore, because the backlight module 4 of the second embodiment of the present invention respectively connects the high-voltage first capacitors C11˜C1N and the high-voltage second capacitors C21˜C2N with two ends of the CCFLs L1˜LN in serial, the operating current flowing through the CCFLs L1˜LN will be balanced due to the same high voltage. The additional balance winding does not need to be installed in the driving unit 40 so that the manufacturing cost is reduced.

The description above only illustrates specific embodiments and examples of the invention. The invention should therefore cover various modifications and variations made to the herein-described structure and operations of the invention, provided they fall within the scope of the invention as defined in the following appended claims.

1. A multi-lamp backlight module, being used for a liquid crystal display panel, comprising:
a control circuit board;
a driving transformer having a secondary side, wherein the driving transformer is located on the control circuit board, and the secondary side of the driving transformer has a first connecting terminal and a second connecting terminal;
a circuit board having at least one capacitor, wherein the circuit board is located on the liquid crystal display panel, and first ends of the capacitors are commonly connected with the first connecting terminal of the secondary side of the driving transformer; and
at least one CCFL located on a back side of the liquid crystal display panel, wherein each of the CCFLs has a first conducting terminal and a second conducting terminal, the first conducting terminals are individually connected with a second end of the capacitors, and the second conducting terminals are commonly connected with a non-ground side of the second connecting terminal of the secondary side of the driving transformer.

2. The multi-lamp backlight module as claimed in claim 1, wherein the capacitor is a high-voltage capacitor.

3. A multi-lamp backlight module, being used for a liquid crystal display panel, comprising:
a control circuit board;
a driving transformer having a secondary side, wherein the driving transformer is located on the control circuit board, and the secondary side of the driving transformer has a first connecting terminal and a second connecting terminal;
a first circuit board having at least one first capacitor, wherein the first circuit board is located on the liquid crystal display panel, and first ends of the first capacitors are commonly connected with the first connecting terminal of the secondary side of the driving transformer;
a second circuit board having at least one second capacitor, wherein the second circuit board is located on another side of the liquid crystal display panel, and first ends of the second capacitors are commonly connected with a non-ground side of the second connecting terminal of the secondary side of the driving transformer; and
at least one CCFL located on the back side of the liquid crystal display panel, wherein each of the CCFLs has a first conducting terminal and a second conducting terminal, the first conducting terminals are individually connected with second ends of the first capacitors, and the second conducting terminals are individually connected with second ends of the second capacitors.

4. The multi-lamp backlight module as claimed in claim 3, wherein the capacitor is a high-voltage capacitor.

5. The multi-lamp backlight module as claimed in claim 3, wherein the driving transformer provides high-voltage signals to drive the CCFLS.

6. A multi-lamp backlight module, being used for a liquid crystal display panel, comprising:
a driving unit having a driving transformer, wherein the driving transformer provides two output terminals;
a backlight unit, comprising:
a circuit board located at the liquid crystal display panel, wherein the circuit board has at least one capacitor, first ends of the capacitors are commonly connected with one output terminal of the driving transformer; and
at least one CCFL located on a back side of the liquid crystal display panel, wherein first ends of the CCFLs are commonly connected with a non-ground side of a second output terminal of the driving transformer, and second ends of the CCFLs are respectively connected with the second ends of the capacitors.

7. The multi-lamp backlight module as claimed in claim 6, wherein the capacitor is a high-voltage capacitor.

8. A multi-lamp backlight module, being used for a liquid crystal display panel, comprising:
a driving unit having a driving transformer, wherein the driving transformer provides two output terminals;
a backlight unit, comprising:
at least one CCFL located on back side of the liquid crystal display panel; and
two circuit boards respectively located on the liquid crystal display panel, wherein each of the two circuit boards has at least one capacitor, first ends of the capacitors of the two circuit boards are respectively connected with the two output terminals of the driving transformer, wherein one of said output terminals is non-ground, and second ends of the capacitors of the two circuit boards are respectively connected with the CCFLs.

9. The multi-lamp backlight module as claimed in claim 8, wherein the capacitor is a high-voltage capacitor.

10. The multi-lamp backlight module as claimed in claim 8, wherein the driving transformer provides high-voltage signals to drive the CCFLS.
